(19) United States
(12) Patent Application Publication
(10) Pub. No.: US 2005/0081079 A1
(43) Pub. Date: Apr. 14, 2005

(54) System and method for reducing trouble tickets and machine returns associated with computer failures

(75) Inventors: Richard W. Cheston, Morrisville, NC (US); Daryl Carvis Cromer, Cary, NC (US); Richard Alan Dayan, Raleigh, NC (US); Howard Jeffrey Locker, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/683,786

(22) Filed: Oct. 10, 2003

(51) Int. Cl. G06F 11/00

(52) U.S. Cl. 714/2

(57) ABSTRACT

A data processing system service and method includes enabling the system to perform diagnostic processing in response to identified system problems and enabling the system to generate a trouble ticket containing machine and problem-specific information. The service and method further include forwarding the trouble ticket to an external server which responds with a unique identifier tied logically to the trouble ticket. The service and method of the present invention requires that requested services such as a help desk call or the return of the system for repair or replacement be obtained only upon presentation of the unique identifier. The system may be partitioned into at least two partitions including a diagnostic partition wherein the diagnostic processing is performed. The system boots to the diagnostic partition upon recognition of a system problem, either automatically or by a user.

### 1. CROSS-REFERENCE TO RELATED APPLICATIONS

The present application is related to the U.S. patent application having Ser. No. ______ (Attorney Docket RPS9 2003 0053) which is filed of even date herewith and which is incorporated herein by reference in its entirety. Ancillary details surrounding the present application which are not central to the present invention may be provided by reference to the incorporated application.

### 2. FIELD OF THE PRESENT INVENTION

The present invention is in the field of data processing systems and more particularly in the area of managing data processing system failures.

### 3. BACKGROUND AND RELATED ART

In the field of data processing systems, the management of returned systems and of systems needing repair or service is a critical factor in maximizing the margins associated with the provision of these systems. Warranty costs associated with servicing machines and with processing and replacing returned machines directly affect the financial bottom line of manufacturers and providers of computers and related services. Using current services procedures, users experiencing system problems or failures may simply return the system to the manufacturer or provider, as long as it is under warranty, for repair or replacement. A significant percentage of such returned systems are found, after investigation upon return, to have no defect. Due to improper use or configuration by the user, or some intermittent behavior poorly understood by a user, these systems were inaccurately diagnosed as failed. This characteristic of warranty-returned machines holds true for personal computers as well as other electronic devices such as servers, printers, point-of-sale devices, etc. It would be desirable to implement a system and process which could avoid the wasteful return of such machines and the associated costs.

Another costly factor in the warranty support of data processing systems is the expense related to fielding help desk calls or providing field service for machines which either are not experiencing a valid problem or where the problem is ill-defined. Users of data processing systems who perceive a problem may call for service without verifying a true problem exists or without making any attempt to diagnose the problem. Help desk and field service personnel must then spend valuable time ascertaining whether a problem exists and identifying the type of service, if any, needed. It would also be desirable to implement a system and process which would require that a user ensure that a problem exists and attempt to identify the nature of such problem prior to contacting a manufacturer or service provider for help. It would be further desirable if the implemented solution did not significantly increase the cost or complexity of owning and/or operating the corresponding data processing systems.

### 4. SUMMARY OF THE INVENTION

The goals described above are achieved in large part according to one embodiment of the present invention by enabling a data processing system which is identified as experiencing problems to run a set of diagnostic routines which will attempt to restore the system to a proper operational state. Failing that, the diagnostics will harvest and store key information about the system and the problem. Such information may include customer and machine identification, software levels and other configuration information, any identified problems such as failing parts, etc. This information will also be forwarded via network connection to a centralized location such as a network administrator or, preferably, an external server located at a help desk-type facility at the manufacturer or other provider of warranty service.

In one embodiment, a customer's data processing system is configured with at least two boot images. The first boot image includes the system's normal operating system while the second boot image includes the automated diagnostic and reporting routines. When a system is experiencing problems, it may be booted into the diagnostic mode. A diagnostic program appropriate for the system is then executed and data indicating the results of various diagnostic tests are recorded. The diagnostic tool may then determine whether the detected problems, if any, may be corrected locally. If the problems can be addressed locally, the system may invoke automated corrective action to attempt to repair the system. The automated corrective action could include actions such as rebooting the system and downloading one or more pieces of computer software (e.g., software drivers), restoring the image to a known good state, or accessing a knowledge database for previous fixes for similar problems. These automated repair functions are not the focus of the present application.

In accordance with an embodiment of the present invention, if the problem cannot be repaired locally or automatically, the selected key information is stored and forwarded as discussed above. In response, the remote server sends the system a confirmation file including a unique identifier called, for example, a Return Material Authorization (RMA) number. The RMA number may also be sent to a network administrator, in the case of an enterprise customer, and/or to an e-mail address so that the user is notified of the receipt of the RMA number even if the system becomes inoperable. In accordance with the present invention, the help desk policies require a user to have an RMA number before calling in for service and before returning a machine for repair or replacement.

The invention according to one embodiment is implemented as a service provided by one or more third parties. In this embodiment of the invention, a provider of data processing systems and/or warranty service provides a customer the automated diagnostic code and then receives and monitors the problem information being reported and the RMA numbers being generated. The warranty service provider will require that users run the provided diagnostic programs before receiving service from the help desk and before returning a system for repair or replacement. The warranty service provider may even implement an automated help desk phone system requiring the input of an RMA number in order to reach the help desk personnel. Once a valid RMA number has been entered, the service personnel manning the help desk will have access to the problem information reported by the system, allowing them to more easily diagnose the problem. Eventually, users will be educated to run the provided diagnostic programs before calling the help desk.

### 5. BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing network used in conjunction with one embodiment of the present invention;

FIG. 2A is a flow diagram of a method of problem recognition and reporting in a data processing system according to one embodiment of the invention;

FIG. 2B is a flow diagram of a method of problem recognition and reporting in a data processing system according to an alternate embodiment of the invention;

FIG. 3 is a flow diagram of the method of FIG. 2A or 2B implemented in a data processing system configured with two alternate boot environments;

FIG. 4A is a flow diagram of the provision of problem diagnosis and service by a third party provider according to the method of FIG. 2A;

FIG. 4B is a flow diagram of the provision of problem diagnosis and service by a third party provider according to the method of FIG. 2B;

FIG. 5 is a flow diagram of a method according to one embodiment of the present invention from the perspective of a user; and

FIG. 6 is a flow diagram of a method according to one embodiment of the present invention from the perspective of a service provider.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### 6. DETAILED DESCRIPTION OF THE INVENTION

Generally speaking, the present invention contemplates systems and methods for improving the failure management of data processing systems and, especially, of reducing the number of service calls and returned machines associated with such failures. A customer's data processing systems are configured to include diagnostic code capable of evaluating the health of the system and, at a minimum, gathering configuration and identification information about the system. Preferably, the diagnostic code is capable of pinpointing the cause of the problems being experienced under many circumstances. In accordance with any of several embodiments of the present invention, the execution of the diagnostic code may be initiated in several different ways. The diagnostic code may be executed at the request of a user. A user might make such a request when a system begins exhibiting problematic symptoms. Alternatively, a system may be configured to run the diagnostic code automatically in certain situations. The diagnostic code may be run automatically when a system crashes and is re-booted. Or, a system may be configured to recognize certain symptoms of impending or actual system failure and execute the diagnostic code automatically, without user intervention.

When executed, the diagnostic code will evaluate the system's condition. Any problems are identified, including any failing part information. Other system information may be harvested as well, such as client and machine identification, software and hardware configuration, Desktop Management Interface (DMI) structures, etc. In addition, the diagnostic code may attempt to take automatic, corrective action to actually alleviate the problem(s) being experienced. The automatic correction aspects of the diagnostic code is beyond the scope of this invention and is explained in more detail in the incorporated application (Ser. No. ______, Attorney Docket RPS9 20030053). All of the gathered information is stored locally on the failing system and may also be stored locally within the enterprise network for access by a LAN administrator or the like. More importantly, in accordance with the various embodiments of the present invention, this information is gathered in a form known as a trouble ticket and the trouble ticket is forwarded to a pre-specified, remote server. This remote server is located at the manufacturer or other provider of the system, or at a third-party provider of system service. The remote server is configured to receive and store the information sent by the failing system. The remote server will also respond to the failing system with a unique identifier tied to the trouble ticket. For convenience, this unique identifier will be referred to herein as a Return Machine Authorization (RMA) number and the remote server may be referred to as an RMA server. The RMA number may also be forwarded to a centralized location, like a network administrator, and/or to an e-mail address. In this way, the RMA number will be received even if the system is completely inoperable.

In accordance with one embodiment of the present invention, the remote RMA server is configured to make the information received from failing systems available to service personnel, searchable by RMA number or other criteria. As such, when a user calls in for help with an RMA number, the service personnel will have readily available information about the hardware and software configuration of the machine and about the problem being experienced. Access to such information will significantly ease the process of providing a user with help and advice relative to the failing system. The RMA number will also be included when a user returns a system for repair or replacement. Again, the service personnel will have access to the RMA number database, allowing the machine failure to be diagnosed much more quickly and easily.

Turning now to the drawings, selected elements of a representative data processing network 100 on which the present invention might be beneficially employed is depicted. The depicted network includes a local area network (LAN) 102 connected through a gateway device 130 to a wide area network (WAN) 106. Also shown is an external server 140 and database 142 connected to WAN 106 via which an external provider may install, configure, or otherwise provide automated data processing repair functionality to LAN 102.

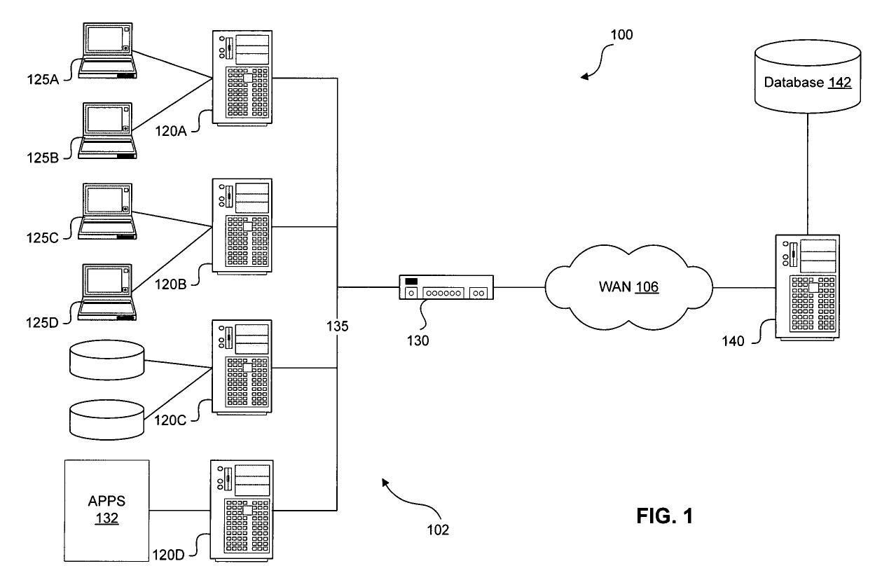

In the depicted embodiment, LAN 102 is representative of an enterprise's data processing network. LAN 102 includes a set of servers 120A through 120D (generically or collectively server(s) 120) to which various devices and systems are connected. Servers 120A and 120B are both connected to a set of data processing systems 125A through 125D. Each data processing system 125 represents a microprocessor-based data processing system such as a desktop or notebook personal computer, a network computer, and so forth. LAN 102 is also shown as including a server 120C connected to disk storage of the network, and an application server 120D that provides applications 132 accessible to data processing systems 125. The set of servers 120 are shown as connected to a gateway device 130 over a network medium 135. LAN 102 and network medium 135 may be implemented as and compliant with an Ethernet network as specified in IEEE Std. 802.3 or as any other appropriate network configuration, as they are well know in the art. The configuration of FIG. 1 is, of course, merely an illustration of a possible representative network useful for describing aspects of the present invention. Those skilled in the design of local area networks and enterprise systems will recognize that the inventive concepts described below may be applied to other configurations with equivalent effect.

Substantial portions of the present invention may be implemented as a set or sequence of computer executable instructions (i.e., computer software). In such embodiments, the software may be stored on any of a variety of computer readable media including, as examples, magnetic disks and or tapes, floppy drives, CD ROM's, flash memory devices, ROM's and so forth. During periods when portions of the software are being executed, the instructions may also be stored in the system memory (DRAM) or internal or external cache memory (SRAM).

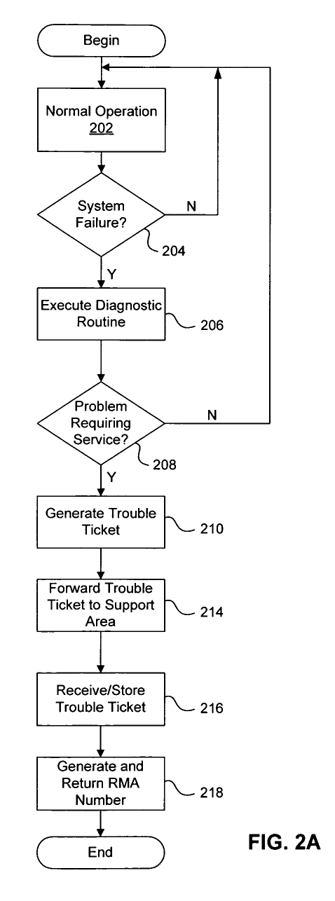

Referring now to FIG. 2A, a flow diagram illustrating selected elements of one embodiment of a method 200 of managing the maintenance of a data processing system such as one of the data processing systems 125 of FIG. 1 is presented. In the depicted embodiment, method 200 includes an initial block (block 202) in which a representative data processing system 125 is functional and executing in its normal operating state.

System 125 remains in this normal operational state until a failure is detected (block 204). The failure detected in block 204 is typified by an operating system crash or failure that renders the system fully or substantially nonfunctional. Other failures that may be detected in block 204 include hardware interrupts generated by various components of the system. It is also possible that a user may decide system 125 is not working properly and manually start the diagnostic code by causing the system to recognize a failure. This can be done in various ways including having the user set a fail flag, including a special key sequence, providing an appropriate menu structure or using any other appropriate method known to those skilled in the art. When a failure is detected in block 204, system 125 enters or invokes (block 206) an automated diagnostic routine or agent.

A determination is made (block 208) following execution of the diagnostic routine of whether a problem has been detected in system 125 which requires service. If a problem has been identified, a trouble ticket is generated (block 210). The trouble ticket will include information concerning the time and date of the failure, serial number or other tracking information about the system and as much detail as possible about the nature and cause of the identified problem.

The trouble ticket generated in response to the problem is forwarded (block 214) to a support area (which may be local, external, or both). This support area is represented in FIG. 1 by an external server 140 and database 142. In other embodiments, the trouble ticket information is stored locally either on the failing system itself or somewhere within the LAN's storage. The received trouble tickets are then stored (block 216) in the database, along with other received trouble tickets, for subsequent use in debugging and repairing the problem. In response to the receipt of the trouble ticket, a service authorization response, known as a Return Machine Authorization (RMA) number, is generated and returned (block 218) to the system experiencing the problem.

In an alternate embodiment, elements of which are more fully disclosed in the incorporated application (Ser. No. ______, Attorney Docket RPS9 20030053), a trouble ticket is generated and forwarded regardless of whether a problem requiring service has been identified. Referring now to FIG. 2B for a depiction of this alternate embodiment, if a problem has been identified (block 208), a trouble ticket is generated (block 210) as in the embodiment discussed above. In this embodiment, however, since a trouble ticket will be generated even if a problem requiring service has not been identified, a special RMA request must also be generated (block 220). If it was determined in step 208 that a problem requiring service was not identified, this may mean that no valid problem was being experienced, that the problem was intermittent and has corrected itself, or that the diagnostic code has successfully alleviated the problem automatically. In any event, in this embodiment of the present invention, a ‘no-service’ trouble ticket is generated (block 222) including, in addition to the source or nature of any problem, the diagnostic corrective action that was effective in resolving the problem and all of the information of a ‘normal’ trouble ticket. The incorporated patent application provides more detailed information concerning the motivation for creating a trouble ticket when no problem was identified or when the problem was repaired automatically, concerning the information to be included in such a trouble ticket and concerning the use of such information by service personnel. These details are beyond the scope of the present invention.

Whether a problem was identified or not, the trouble ticket and the RMA request (if created) are forwarded (block 224) to the support area. As before, the trouble ticket is received and stored in the database (block 216). At block 226, a determination is made if an RMA request accompanied the received trouble ticket. If an RMA request was received, an RMA number is generated and returned (block 218) to the requesting system.

In one embodiment of the present invention, a customer's data processing systems are configured to include at least two boot images (i.e., at least two modes of operation following a system reset or system power on). A first boot image represents the system's conventional operating system (OS) while the second boot image is a diagnostic image that may be invoked following a system failure or identified system problem. In this embodiment, the diagnostic routine (or code) discussed above would become operative as a result of the system booting into this diagnostic image.

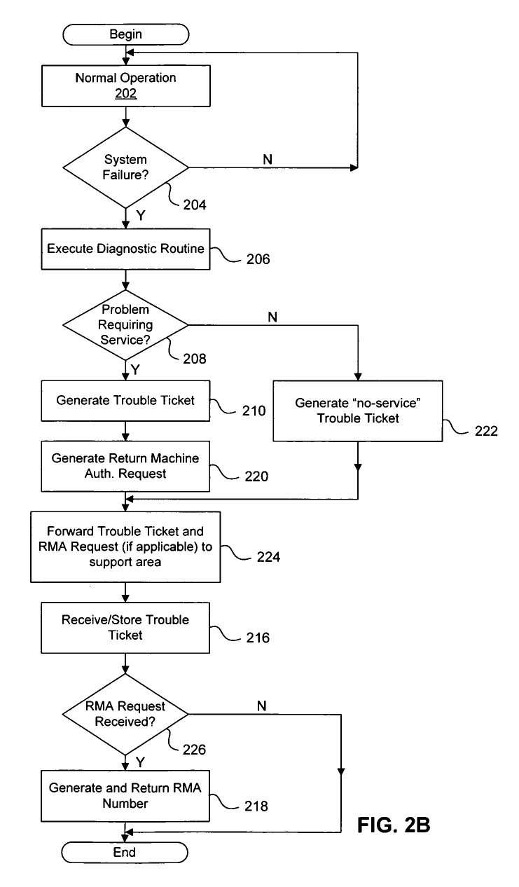

This bootable diagnostic image or routine may be stored in the system BIOS, on a bootable device such as a CD or USB-connected device, and/or in a protected and secure area of the hard drive on system 125. It may also be stored remotely on the network where the system 125 has the ability to remotely boot using remote Pxe or other industry standard remote boot capability, as such capabilities are well known to those skilled in the relevant arts. This bootable diagnostic routine is invoked following a system failure or identified system problem. In this embodiment, as illustrated in greater detail by the flow diagram of FIG. 3, system 125 is configured, either by the customer or by a third party service provider, with dual boot images. The first boot image represents the system's normal operating system while the second image is the automated diagnostic routine.

In the embodiment 300 depicted in FIG. 3, system 125 monitors for or detects (block 302) the occurrence of a system reset. When a reset is detected, system 125 then determines (block 304) whether a fail flag or some other suitable indicator of a system failure or problem has been set. If the fail flag is set, system 125 boots itself to the diagnostic routine or configuration (block 306). If the fail flag is not set, thereby indicating that the power reset was not caused by a system failure or problem, system 125 boots (block 308) its normal operating system image and normal operation continues until a subsequent reset is observed. As discussed above, it is also possible for the user to force the system to boot to an automated debug configuration. This can be done in various ways including have the user set the fail flag, and or have a boot menu which allows the user to choose the desired boot image, or have a key sequence at power on that forces a boot to the automated debug configuration.

After booting the system into its diagnostic image in block 306, the diagnostic code is executed (block 310). The diagnostic code may take various actions, including corrective action as described in the incorporated application (Ser. No. ______, Attorney Docket RPS9 20030053), and as described above. The diagnostic code then generates a trouble ticket (block 312) and forwards the trouble ticket to the support area (block 314) as described in the embodiment of the present invention depicted in FIG. 2A. Alternatively, the diagnostic code of the diagnostic image present in the embodiment depicted in FIG. 3 may implement the trouble ticket creation and forwarding according to the embodiment shown in FIG. 2B (not shown in FIG. 3).

The Diagnostic code then resets the fail flag (block 316) and re-boots the data processing system 125 (block 318). Since the fail flag has been reset, the system will boot into it's normal operation system and operate in a normal mode as allowed by the continued existence of any problem(s).

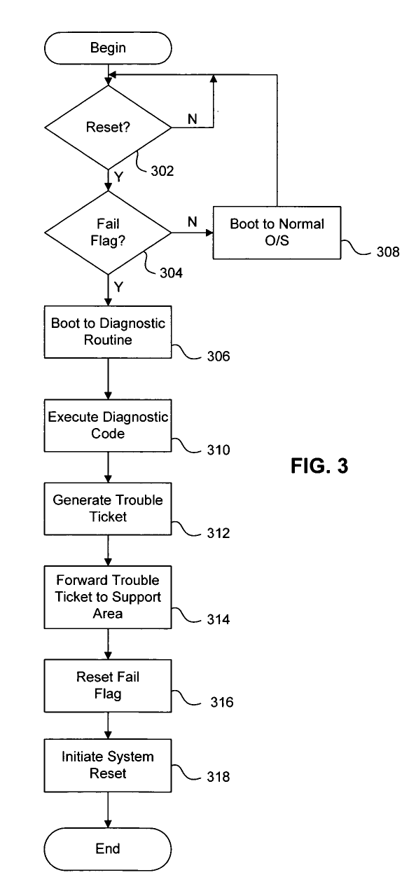

In an embodiment emphasized by the flow diagram of FIG. 4A, the present invention is implemented as a service provided to a data processing customer by one or more suppliers. More specifically, the flow diagram of FIG. 4A illustrates a method 400 of providing automated diagnostic services to a customer. In the depicted embodiment, the method 400 includes an initial step in which the diagnostic routine or agent is provided (block 402) to a customer. The provision of this software may include installation of the software and/or configuration of the customer's system 125 to enter and execute the diagnostic facility properly. In other embodiments, the installation and/or configuration associated with the diagnostic routine is performed by the customer. In the embodiment emphasized by the flow diagram of FIG. 4A, the provider of the diagnostic functionality is also a provider of diagnostic support services. In this embodiment, the provider is configured to detect (block 404) the receipt of trouble tickets documenting problems requiring service which are generated and forwarded by a customer's system.

Referring momentarily back to FIG. 1, the provider of the diagnostic functionality and services is represented by the external server 140 and the external database 142. As depicted in FIG. 1, external server 140 is accessible to LAN 102 via a wide area network such as the Internet. In this implementation, external server 140 is configured to deliver the diagnostic functionality to the system 125 on LAN 102. The delivery of this functionality may be achieved similar to the manner in which BIOS and other firmware updates are made in conventional network attached systems. In other embodiments, the configuration of a system 125 to include the diagnostic functionality may require local action such as a local technician or system administrator inserting a CD or other medium into the appropriate system and booting the system. It is also possible to configure the system to add the diagnostic functionality natively to the system. This is a one time prep step which can be received from a remote server or run from the network, a CD or a USB device. It will set aside part of the hard drive and copy the diagnostic functionality onto the drive.

Upon detecting the receipt of a trouble ticket, the diagnostic service provider stores (block 406) the trouble ticket information in a database such as database 142 depicted in FIG. 1. In this embodiment of the present invention, the receipt of a trouble ticket also serves as a request for an RMA number. Therefore, at block 408, an RMA number is generated and returned to the requesting system. The RMA number may also be returned to a central location, such as a system administrator's data processing system located on LAN 102 (See FIG. 1) or to an e-mail address. In this way, the RMA number can be received even if the requesting system is inoperative.

Alternatively, the method 400 may contemplate the receipt of trouble tickets which do not correspond to problems requiring service. In such an embodiment, trouble tickets corresponding to problems requiring service would be accompanied by a request for an RMA number. Referring now to FIG. 4B, once a received trouble ticket has been stored (block 406), a determination is made if an RMA request accompanied the trouble ticket (block 420). If an RMA request accompanied the trouble ticket, an RMA number is generated and returned (block 408) as before. If no RMA request was received, the system returns 422 to monitor for further trouble tickets.

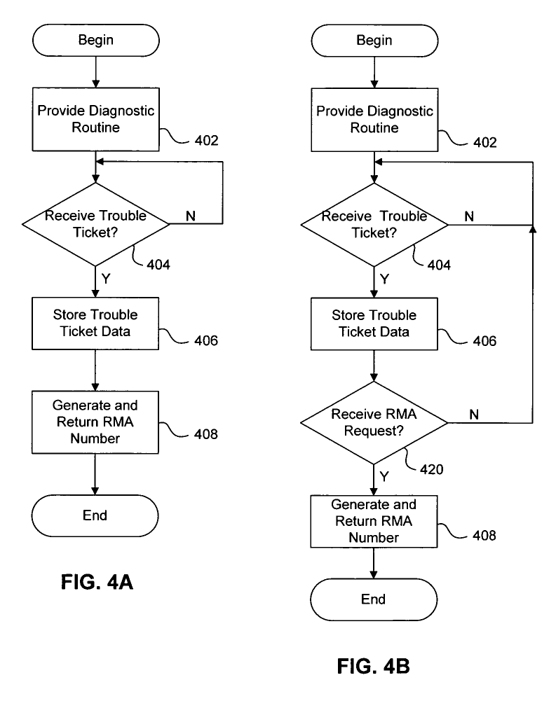

In order to achieve the full benefit of the various embodiments of the present invention, policies are created and implementing requiring that a user have an RMA number before receiving any service support from the manufacturer or diagnostic service provider. In this way, a user is forced to execute the provided diagnostic code before calling for help or returning a machine for warranty repair or replacement. By executing the diagnostic code, a certain percentage of the identified problems will be resolved with no service personnel intervention, either as intermittent or non-existent problems or as problems resolved automatically by the diagnostic code. Even for the problems requiring service personnel intervention, the reliable system and problem information delivered via the generated trouble tickets will allow such problems to be diagnosed and resolved much more quickly and efficiently. FIG. 5 depicts a user perspective of such an embodiment. After a problem with system 125 is identified (block 502), either automatically by the system or by the user as discussed above, the diagnostic code is executed (block 504) according to one of the various embodiments of the present invention, also discussed above. Transparent to the user, the execution of the diagnostic code 504 generates a trouble ticket describing the problem and forwards it to the support area for storage in a database (see FIG. 2A). The user then receives an RMA number (block 506). The RMA number may be received at the requesting data processing system 125, or at a central location like the system of a LAN administrator (not shown) or even at an e-mail address (in the event the requesting system is inoperative). The user may then request a service action from the support personnel (block 508). The service actions contemplated include a call to a help desk for aid it debugging a problem, a request for on-site service or even a return of a machine for service or replacement. In accordance with the policies established in accordance with the present invention, the support personnel will ask the user to provide an RMA number associated with the problem. The RMA number will allow the support personnel to access the trouble ticket information, significantly speeding the diagnosis and repair of the problem.

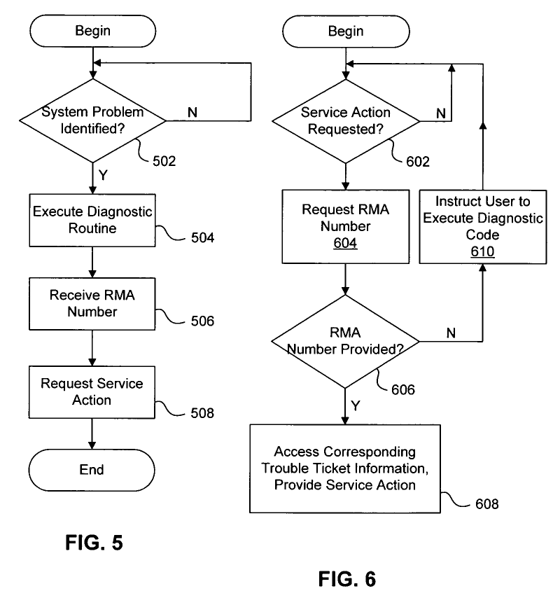

FIG. 6 illustrates, from the perspective of the support personnel, the situation where a user has requested a service action without first executing the diagnostic code. At block 602, a request for a service action is received by the support personnel. The request may be for a service action, such as a help desk call or a request for on-site service. As required by established policies, the support personnel ask the requesting user for an RMA number (block 604). At 606, if an RMA number is provided, the support personnel access the accompanying trouble ticket information and provide the requested service action (block 608). However, if no RMA number is provided (block 606), the support personnel instruct the user (block 610) to execute the diagnostic code, withholding the requesting service action.

This embodiment of the present invention may advantageously be implemented in an automated help desk calling system. In such an implementation, a user calling in for service would be prompted (block 604) to input, via the touch-tone pad on the phone, for instance, an RMA number. Upon recognition of a valid RMA number (block 606), the user would be connected to an actual support person for help. At the same time, the automated system could find and present the trouble ticket information associated with the RMA number to the support personnel fielding the call. In this way, the support personnel could more easily and efficiently provide the requested service action (block 608). If no valid RMA number is input (block 606), the user would automatically be instructed to execute the diagnostic code (block 610) in order to obtain an RMA number.

If the subsequent execution of the diagnostic code results in the identification of a problem requiring service, then the user will receive an RMA number in accordance with any one of the various embodiments of the present invention (see FIGS. 2A, 2B, 3, 5) and will be able to successfully request a service action. Eventually, users will be educated to always execute the diagnostic code prior to requesting any service action. Such education may take place via product literature, web sites, service personnel contact, etc.

In the event that a data processing system 125 has experienced such a catastrophic failure as to be unable to execute the diagnostic routine, the advantages of the present invention would be unavailable and service would be obtained according to current techniques and procedures. Help desk exception policies would be implemented to allow service actions to be requested without an RMA number when a user is unable to obtain one.

It will be apparent to those skilled in the art having the benefit of this disclosure that the present invention contemplates automated failure management for a data processing system. It is understood that the form of the invention shown and described in the detailed description and the drawings are to be taken merely as presently preferred examples. It is intended that the following claims be interpreted broadly to embrace all the variations of the preferred embodiments disclosed.

1. A data processing system management service, comprising:
configuring a data processing system with diagnostic code for generating a trouble ticket containing information characterizing a system problem;
enabling the data processing system to forward the trouble ticket to a remote server;
configuring the remote server to receive the trouble ticket and respond with a return machine authorization number.

2. The service of claim 1, wherein the diagnostic code is executed in response to an event selected from a user requesting the execution due to a suspected system problem and the system detecting a problem.

3. The service of claim 1 wherein the trouble ticket further comprises machine and user identification information and wherein the remote server is further configured to store the trouble ticket information in a service record database.

4. The service of claim 3 further comprising enabling a user of the data processing system to, in response to the receipt of the return machine authorization number, request a service action from service personnel.

5. The service of claim 4 further comprising configuring the service record database to permit service personnel to utilize the trouble ticket information to aid in problem determination and resolution.

6. The service of claim 4 wherein the service action comprises a request selected from a call to a help desk for remote problem determination and repair and a return of the system to the service personnel for repair or replacement.

7. The service of claim 4 further comprising requiring the user to provide the return machine authorization number prior to providing any service action.

8. The service of claim 3, wherein configuring the data processing system with diagnostic code is further characterized as configuring the data processing system with an operational partition and a diagnostic partition capable of executing the diagnostic code.

9. The service of claim 8, further comprising configuring the system to boot the diagnostic partition in response to an event selected from a user requesting the execution of the diagnostic code due to a suspected system problem and the system detecting a problem.

10. The service of claim 9 wherein the diagnostic partition is located on a bootable device operably connected to the system.

11. The service of claim 10 wherein the diagnostic partition is located on a data processing system remotely connected to the system experiencing the problem via a network.

12. The service of claim 8 further comprising enabling a user of the data processing system to, in response to the receipt of the return machine authorization number, request a service action from service personnel.

13. The service of claim 12 further comprising configuring the service record database to permit service personnel to utilize the trouble ticket information to aid in problem determination and repair.

14. The service of claim 12 wherein the service action comprises a request selected from a call to a help desk for remote problem determination and repair and a return of the system to the service personnel for repair or replacement.

15. The service of claim 12 further comprising requiring the user to provide the return machine authorization number prior to providing any service action.

16. The service of claim 1 wherein the trouble ticket is generated and forwarded regardless of whether the system problem requires service; further comprising:
configuring the data processing system to generate a return machine authorization request only if the system problem requires service;
enabling the data processing system to forward the return machine authorization request to the remote server;
and wherein;
the remote server responds with a return machine authorization number only upon receipt of a return machine authorization request.

17. The service of claim 4 wherein the trouble ticket is returned to the user at a location other than the data processing system.

18. A computer program product comprising computer executable instructions, stored on a computer readable medium, for managing a data processing system, comprising:
computer code means for performing diagnostic processing responsive to an event selected from a user requesting the diagnostic processing in response to a suspected system problem and the system detecting a problem;
computer code means for generating a trouble ticket identifying the system and characterizing the problem;
computer code means for forwarding the trouble ticket to a remote server;
computer code means operative on the remote server for receiving the trouble ticket, storing the trouble ticket in a database, and responding with a return machine authorization number.

19. The computer program product of claim 18 wherein performing diagnostic processing comprises booting a diagnostic partition of the data processing system containing the diagnostic processing code means.

20. The computer program product of claim 18 wherein the trouble ticket is generated and forwarded regardless of whether the system problem requires service; further comprising:
computer code means for generating a return machine authorization request only if the system problem requires service;
computer code means for forwarding the return machine authorization request to the remote server;
and wherein;
the computer code means operative on the remote server responds with a return machine authorization number only upon receipt of a return machine authorization request.

21. A method comprising the steps of:
executing, in response to an identified problem with a data procesing system, a diagnostic routine for generating a trouble ticket containing information characterizing the system problem and identifying the system configuration;
forwarding the trouble ticket to a remote server;
receiving the trouble ticket at the remote server and storing the trouble ticket information in a database;
responding with a return machine authorization number.

22. The method of claim 21, wherein the system problem is identified by one of (i) automatically by the system and (ii) a user.

23. The method of claim 21 further comprising enabling a user of the data processing system to, in response to the receipt of the return machine authorization number, request a service action from service personnel.

24. The method of claim 23 further comprising accessing the database to permit the service personnel to utilize the trouble ticket information to aid in problem determination and resolution.

25. The method of claim 24 wherein the service action comprises a request selected from a call to a help desk for remote problem determination and repair and a return of the system to the service personnel for repair or replacement.

26. The method of claim 24 further comprising requiring the user to provide the return machine authorization number prior to providing any service action.

27. The method of claim 22, wherein the data processing system is configured with at least an operational partition and a diagnostic partition and wherein executing the diagnostic routine comprises booting the system to the diagnostic partition.

28. The method of claim 27 wherein the diagnostic partition is located on a bootable device operably connected to the system.

29. The method of claim 28 wherein the diagnostic partition is located on a data processing system remotely connected to the system experiencing the problem via a network.

30. The method of claim 27 further comprising enabling a user of the data processing system to, in response to the receipt of the return machine authorization number, request a service action from service personnel.

31. The method of claim 30 further comprising accessing the database to permit the service personnel to utilize the trouble ticket information to aid in problem determination and repair.

32. The method of claim 31 wherein the service action comprises a request selected from a call to a help desk for remote problem determination and repair and a return of the system to the service personnel for repair or replacement.

33. The method of claim 32 further comprising requiring the user to provide the return machine authorization number prior to providing any service action.

34. The method of claim 21 wherein the trouble ticket is generated and forwarded regardless of whether the system problem requires service; further comprising:
generating a return machine authorization request only if the system problem requires service;
forwarding the generated return machine authorization request to the remote server;
and wherein;
the remote server responds with a return machine authorization number only upon receipt of a return machine authorization request.

35. The method of claim 23 wherein the return machine authorization number is returned to the user at a location other than the data processing system.
